(19) United States
(12) Patent Application Publication
(10) Pub. No.: US 2024/0094492 A1
(43) Pub. Date: Mar. 21, 2024

(54) OPTICAL FIBER CABLE HAVING LOW FREE SPACE AND HIGH FIBER DENSITY

(71) Applicant: CORNING RESEARCH & DEVELOPMENT CORPORATION, Corning, NY (US)

(72) Inventors: Leigh Rooker Josey, Hickory, NC (US); Snigdharaj Kumar Mishra, Wilmington, NC (US); Sebastian Olszewski, Aleksandrów (PL); David Alan Seddon, Hickory, NC (US); Pushkar Tandon, Painted Post, NY (US)

(21) Appl. No.: 18/515,679

(22) Filed: Nov. 21, 2023

Related U.S. Application Data
(63) Continuation of application No. PCT/US2022/029803, filed on May 18, 2022.
(60) Provisional application No. 63/194,318, filed on May 28, 2021.

(51) Int. Cl. G02B 6/44; G02B 6/02

(52) U.S. Cl. CPC G02B 6/4434; G02B 6/02395

(57) ABSTRACT

Provided are embodiments of an optical fiber cable. The optical fiber cable includes a cable jacket having an inner surface and an outer surface. The inner surface defines a central cable bore, and the outer surface defines an outermost surface of the optical fiber cable and a cable cross-sectional area (A_{C}). At least one buffer tube is disposed within the central cable bore. Each buffer tube has an interior surface defining a buffer tube cross-sectional area (A_{Tube, ID}). A plurality of optical fibers (N) are disposed within the at least one buffer tube. Each optical fiber has a fiber diameter of 160 microns to 200 microns. The plurality of optical fibers have a total fiber area (A_{F}). The buffer tube has a free space (1−A_{F}/A_{Tube, ID}) of at least 37%, and the optical fiber cable has a fiber density (N/A_{C}) of at least 3.25 fibers/mm².

### CROSS-REFERENCE TO RELATED APPLICATION

This application is a continuation of International Patent Application No. PCT/US2022/029803 filed May 18, 2022, which claims the benefit of priority under 35 U.S.C. § 119 of U.S. Provisional Application No. 63/194,318, filed on May 28, 2021, the content of which is relied upon and incorporated herein by reference in its entirety.

### BACKGROUND OF THE DISCLOSURE

The present disclosure generally relates to optical fiber cables and in particular to optical fiber cables having a high density of optical fibers and low free space. In general, an optical fiber cable needs to carry more optical fibers in order to transmit more optical data, and in order to carry more optical fibers, the size of the optical fiber cable needs to be increased. The increased size is at least partially the result of free space considerations to avoid macro- and micro-bending losses. For existing installations, size limitations and duct congestion limit the size of optical fiber cables that can be used without the requirement for significant retrofitting. Thus, it may be desirable to provide optical fiber cables having a higher fiber density (i.e., more fibers per cross-sectional area of the cable) without increasing the cable diameter such that the high fiber density cables can be used in existing ducts.

### SUMMARY OF THE DISCLOSURE

In one aspect, embodiments of the present disclosure relate to an optical fiber cable. The optical fiber cable includes a cable jacket having an inner surface and an outer surface. The inner surface defines a central cable bore, and the outer surface defines an outermost surface of the optical fiber cable and a cable cross-sectional area (A_{C}). In one or more embodiments, at least one buffer tube is disposed within the central cable bore. In such embodiments, each buffer tube of the at least one buffer tube may have an interior surface defining a buffer tube cross-sectional area (A_{Tube, ID}). In one or more embodiments, a plurality of optical fibers (N) are disposed within the at least one buffer tube. Each optical fiber of the plurality of optical fibers has a fiber diameter of 160 microns to 200 microns, and the plurality of optical fibers have a total fiber area (A_{F}). The buffer tube has a free space (1−Δ_{F}/Δ_{Tube, ID}) of at least 37%, and the optical fiber cable has a fiber density (N/A_{C}) of at least 3.25 fibers/mm².

In another aspect, embodiments of the present disclosure relate to an optical fiber cable. The optical fiber cable includes a cable jacket having an inner surface and an outer surface. The inner surface defines a central cable bore, and the outer surface defines an outermost surface of the optical fiber cable and a cable cross-sectional area (A_{C}). A plurality of buffer tubes are disposed within the central cable bore. A number of optical fibers (N) are disposed within the plurality of buffer tubes such that each buffer tube of the plurality of buffer tubes includes at least twelve optical fibers. Each optical fiber of the number of optical fibers includes a germania-doped silica core, a cladding region comprising a fluorine-doped silica trench, a primary coating having a first elastic modulus of less than 1 MPa and a first glass transition temperature of less than −20° C., and a secondary coating having a second elastic modulus of greater than 1500 MPa and a second glass transition temperature of greater than 65° C. The number of optical fibers is at least 192 and the optical fiber cable comprises a fiber density (N/A_{C}) of at least 3.25 fibers/mm².

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiments, and together with the description serve to explain principles and operation of the various embodiments.

### BRIEF DESCRIPTION OF THE DRAWINGS

FIG. 1 is an end view of an optical fiber, according to an exemplary embodiment;

FIG. 2 is a graph illustrating the refractive index design profile of an optical fiber of FIG. 1 having a rectangular trench, according to an exemplary embodiment;

FIG. 3 is a graph illustrating the refractive index design profile of an optical fiber of FIG. 1 having a triangular trench, according to an exemplary embodiment;

FIG. 4 depicts a high fiber density, low free space optical fiber cable, according to an exemplary embodiment;

FIG. 5 is graph depicting thermal cycling test performance for high fiber density cable designs having optical fibers of various diameters, according to exemplary embodiments; and

FIG. 6 is a graph illustrating thermal cycling test performance for an optical fiber cable having various optical fiber types, according to exemplary embodiments.

### DETAILED DESCRIPTION

Reference will now be made in detail to the present preferred embodiments, examples of which are illustrated in the accompanying drawings. Whenever possible, the same reference numerals will be used throughout the drawings to refer to the same or like parts.

The following detailed description represents embodiments that are intended to provide an overview or framework for understanding the nature and character of the claims. The accompanied drawings are included to provide a further understanding of the claims and constitute a part of the specification. The drawings illustrate various embodiments, and together with the descriptions serve to explain the principles and operations of these embodiments as claimed.

“Refractive index” refers to the refractive index at a wavelength of 1550 nm.

The “refractive index profile” is the relationship between refractive index or relative refractive index and waveguide fiber radius. The radius for each region of the refractive index profile is given by the abbreviations r₁, r₂, r₃, r₄, etc. and lower and upper case are used interchangeably herein (e.g., r₁ is equivalent to R₁).

The “relative refractive index percent” is defined as Δ %=100×(nᵢ²−n_{c}²)/2nᵢ², and as used herein nᵢ is the refractive index of region i of the optical fiber and n_{c} is the refractive index of undoped silica. As used herein, the relative refractive index is represented by Δ and its values are given in units of “%”, unless otherwise specified. The terms: delta, Δ, Δ %, % Δ, delta %, % delta, and percent delta may be used interchangeably herein. In cases where the refractive index of a region is less than the average refractive index of undoped silica, the relative index percent is negative and is referred to as having a depressed region or depressed index. In cases where the refractive index of a region is greater than the average refractive index of the cladding region, the relative index percent is positive.

An “updopant” is herein considered to be a dopant which has a propensity to raise the refractive index relative to pure undoped SiO₂. Examples of updopants include GeO₂ (germania), Al₂O₃, P₂O₅, TiO₂, Cl, Br.

A “downdopant” is herein considered to be a dopant which has a propensity to lower the refractive index relative to pure undoped SiO₂. Examples of down dopants include fluorine and boron.

“Chromatic dispersion”, herein referred to as “dispersion” unless otherwise noted, of a waveguide fiber is the sum of the material dispersion, the waveguide dispersion, and the inter-modal dispersion. In the case of single mode waveguide fibers, the inter-modal dispersion is zero. Zero dispersion wavelength is a wavelength at which the dispersion has a value of zero. Dispersion slope is the rate of change of dispersion with respect to wavelength.

“Effective area” is defined as:

$${A}_{e f f} = \frac{2 {π [ {\int }_{0}^{∞} {( f ( r ) )}^{2} r d r ]}^{2}}{{\int }_{0}^{∞} {( f ( r ) )}^{4} r d r}$$

where f(r) is the transverse component of the electric field associated with light propagated in the waveguide. As used herein, “effective area” or “Δ_{eff}” refers to optical effective area at a wavelength of 1550 nm unless otherwise noted.

The trench volume V₃ is defined for a depressed index region

$${V}_{3} = \vert 2 {\int }_{{r}_{Trench , inner}}^{{r}_{Trench , outer}} ( {Δ}_{T r e n c h} ( r ) - {Δ}_{c} ) rdr \vert$$

where r_{Trench,inner} is the inner radius of the trench cladding region, r_{Trench,outer} is the outer radius of the trench cladding region, Δ_{Trench}(r) is the relative refractive index of the trench cladding region, and Δ_{c} is the average relative refractive index of the common outer cladding region of the glass fiber. In embodiments in which a trench is directly adjacent to the core, r_{Trench,outer} is r₂=r₁ (outer radius of the core), r_{Trench,outer} is r₃, and Δ_{Trench} is Δ₃(r). In embodiments in which a trench is directly adjacent to an inner cladding region, r_{Trench,inner} is r₂>r₁, r_{Trench,outer} is r₃, and Δ_{Trench} is Δ₃(r). Trench volume is defined as an absolute value and has a positive value. Trench volume is expressed herein in units of % Δ-micron², % Δ-μm², or %-micron², %-μm² whereby these units can be used interchangeably.

The term “α-profile” refers to a relative refractive index profile, expressed in terms of Δ(r) which is in units of “%”, where r is radius, which follows the equation,

$$Δ ( r ) = Δ ( {r}_{0} ) [ 1 - {[ \frac{\vert r - {r}_{0} \vert}{( r - {r}_{0}} ]}^{α} ]$$

where rₒ is the point at which Δ(r) is maximum, r₁ is the point at which Δ(r) % is zero, and r is in the range rᵢ≤r≤r_{f}, where Δ is defined above, rᵢ is the initial point of the α-profile, r_{f} is the final point of the α-profile, and α is an exponent which is a real number.

The mode field diameter (MFD) is measured using the Peterman II method wherein,

$$M F D = 2 w$$

$${w}^{2} = 2 \frac{{\int }_{0}^{∞} {( f ( r ) )}^{2} r d r}{{\int }_{0}^{∞} {( \frac{d f ( r )}{d r} )}^{2} r d r}$$

Mode field diameter depends on the wavelength of the optical signal in the optical fiber. Specific indication of the wavelength will be made when referring to mode field diameter herein. Unless otherwise specified, mode field diameter refers to the LP₀₁ mode at the specified wavelength.

The theoretical fiber cutoff wavelength, or “theoretical fiber cutoff”, or “theoretical cutoff”, for a given mode, is the wavelength above which guided light cannot propagate in that mode. A mathematical definition can be found in Single Mode Fiber Optics, Jeunhomme, pp. 39-44, Marcel Dekker, New York, 1990 wherein the theoretical fiber cutoff is described as the wavelength at which the mode propagation constant becomes equal to the plane wave propagation constant in the outer cladding. This theoretical wavelength is appropriate for an infinitely long, perfectly straight fiber that has no diameter variations.

Fiber cutoff is measured by the standard 2 m (2 meter) fiber cutoff test, FOTP-80 (EIA-TIA-455-80), to yield the “fiber cutoff wavelength”, also known as the “2 m fiber cutoff” or “measured cutoff.” The FOTP-80 standard test is performed to either strip out the higher order modes using a controlled amount of bending, or to normalize the spectral response of the fiber to that of a multimode fiber.

By cabled cutoff wavelength, or “cabled cutoff” as used herein, we mean the 22 m (22 meter) cabled cutoff test described in the EIA-445 Fiber Optic Test Procedures, which are part of the EIA-TIA Fiber Optics Standards, that is, the Electronics Industry Alliance—Telecommunications Industry Association Fiber Optics Standards.

Unless otherwise noted herein, optical properties (such as dispersion, dispersion slope, etc.) are reported for the LP₀₁ mode.

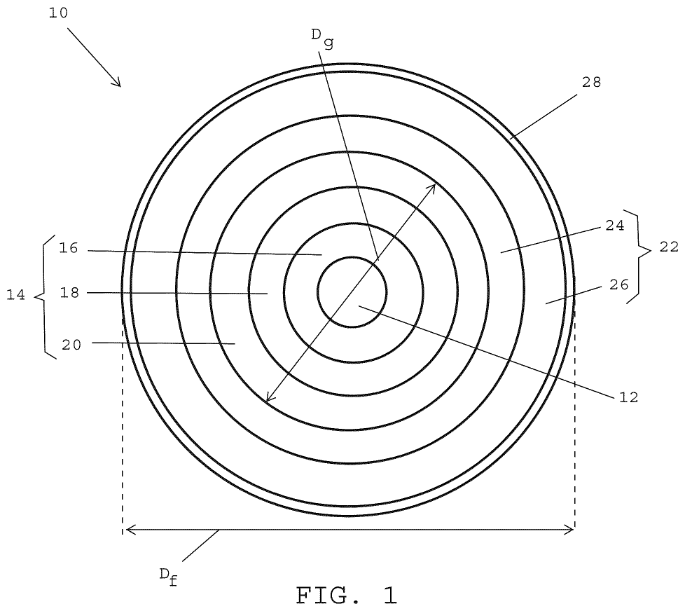

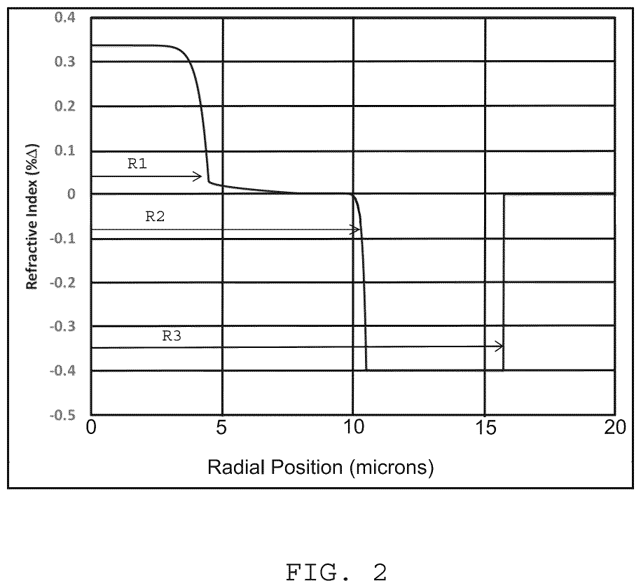

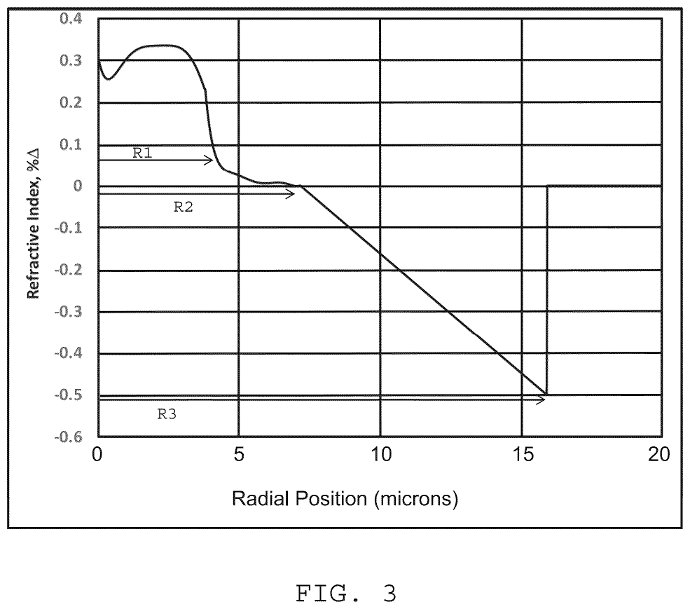

Referring to FIG. 1, the terminal end of optical fibers 10 includes a core 12 surrounded by a cladding region 14. In one or more embodiments, including the embodiment depicted in FIG. 1, the cladding region 14 includes a first cladding layer 16, a second cladding layer 18, and a third cladding layer 20. However, in one or more other embodiments, the cladding region 14 only includes two layers of cladding. In embodiments, the second cladding layer 18 of the three layer cladding region 14 defines a trench region as will be discussed more fully below. In embodiments in which the cladding region 14 only has two layers, the cladding layer adjacent to the core 12 defines the trench region. Further, as will be discussed more fully below, the trench region may have a substantially constant refractive index (referred to as a “rectangular trench”) as shown in FIG. 2, or the trench region may have a continuously varying refractive index (“referred to as a triangular trench”) as shown in FIG. 3.

In one or more embodiments, the cladding region 14 includes a cladding layer (e.g., second cladding layer 18) having a trench volume of greater than about greater than about 25% Δ-μm². In one or more embodiments, the trench volume is greater than about 30% Δ-μm², greater than about 40% Δ-μm², greater than about 50% Δ-μm², or greater than about 60%% Δ-μm². In one or more embodiments, the trench volume is less than about 70% Δ-μm², less than about 65% Δ-μm², or less than about 60% Δ-μm². In one or more embodiments, the trench volume is from about 25% Δ-μm² to about 70% Δ-μm², about 30% Δ-μm² to about 70% Δ-μm², about 40% Δ-μm² to about 70% Δ-μm², about 50% Δ-μm² to about 70% Δ-μm², about 60% Δ-μm² to about 70% Δ-μm², about 30% Δ-μm² to about 60% Δ-μm², about 30% Δ-μm² to about 50% Δ-μm², about 30% Δ-μm² to about 40% Δ-μm², about 40% Δ-μm² to about 60% Δ-μm², or about 50% Δ-μm² to about 60% Δ-μm². For example, the trench volume is about 30% Δ-μm², about 35% Δ-μm², about 40% Δ-μm², about 45% Δ-μm² about 46%% Δ-μm², about 47% Δ-μm², about 48%% Δ-μm², about 49% Δ-μm², about 50% Δ-μm² about 55% Δ-μm² about 60% Δ-μm², about 61% Δ-μm², about 62% Δ-μm², about 68% Δ-μm² about 69% Δ-μm², about 70% Δ-μm², or any trench volume between these values.

In some embodiments, the outer trench radius (corresponding to R3 in FIGS. 2 and 3) is between 11 microns and 20 microns. In other embodiments, the outer trench radius is between 12 microns and 18 microns.

In one or more embodiments, the core 12 and cladding region 14 are comprised of a glass material. In one or more embodiments, the core is comprised of germania-doped silica, and the trench (e.g., second cladding layer 18 in the embodiment of FIG. 1) is comprised of a fluorine-doped silica. In one or more embodiments, the shape of the optical fiber 10 may be a circular end shape or circular cross-sectional shape as shown in FIG. 1. In one or more other embodiments, end and cross-sectional shapes and sizes may be employed including elliptical, hexagonal and various polygonal forms.

In one or more embodiments, the core 12 has a first radius R₁ that is from 4 microns to 6 microns. In one or more embodiments, the first cladding layer 16 has a second radius R₂, the second cladding layer 18 has a radius R₃, and the third cladding layer has a radius R₄. In one or more embodiments, the second radius R₂ is from 7 microns and 13 microns. In one or more embodiments, the third radius R₃ is from 11 microns and 20 microns. In one or more embodiments, the fourth radius R₄ is from 60 microns to 65 microns. The cladding region 14 defines a maximum cross-sectional dimension of the glass of the optical fiber 10. In embodiments in which the optical fiber 10 has a circular end or cross-section, the maximum cross-sectional dimension is a glass diameter D_{g} of the optical fiber 10. In one or more embodiments, the glass diameter D_{g} is from 120 microns to 130 microns.

For the purpose of this disclosure, the refractive index in each of the core 12, first cladding layer 16, and second cladding layer 18 are defined with respect to the refractive index Δ₄ of the third cladding 20, i.e., Δ₄=0% Δ. As shown in FIGS. 2 and 3, the core 12 has a maximum core index of Δ_{1,max}. In one or more embodiments, the maximum core refractive index Δ_{1,max} is between 0.3% Δ and 0.45% Δ. Further, the first cladding layer 16 has an average index of Δ₂. In one or more embodiments, the refractive index Δ₂ is between −0.05% Δ to 0.05% Δ. The second cladding layer 18 defining the fluorine doped trench has a minimum trench index of Δ_{3,min}. In one or more embodiments, the minimum trench refractive index Δ_{3,min} is between −0.1% Δ and −0.5% Δ, in particular between −0.15% Δ and −0.4% Δ.

In one or more embodiments, the core 12 is a step index with a core alpha of greater than 10. In other embodiments, the core 12 is a graded index core having a core alpha between 1.5 and 5. The core alpha is defined as an exponent a wherein the refractive index in the core 12 as a function of radial position is described by the refractive index relation Δ % (r)=Δ_{1,max}*[1−(r/R₁)^{α}].

Disposed around the cladding region 14 is a coating 22 that surrounds and encapsulates the glass core 12 and cladding region 14. In embodiments, the coating 22 is configured to provide mechanical protection for the optical fiber 10. In one or more embodiments, the coating 22 includes an inner or primary coating 24 and an outer or secondary coating 26. In one or more embodiments, the primary coating 24 directly contacts the cladding region 14, and the secondary coating 26 directly contacts the primary coating 24. In one or more embodiments, the secondary coating 24 defines the outermost surface of the optical fiber 10. However, in one or more other embodiments, the optical fiber 10 further includes a color layer 28, which may be used to identify the optical fiber 10. In embodiments in which the color layer 28 is included, the color layer 28 may define the outermost surface of the optical fiber 10.

In one or more embodiments, the outer coating 22 has a thickness in the range of 22-45 microns, or in the range of 22-40 microns, or in the range of 22-35 microns. In one or more embodiments, the coating 22 has a ratio of the thickness of the secondary coating 26 to the thickness of the primary coating 24 in the range of 0.65 to 1.0. According to one or more other embodiments, the ratio of the secondary coating 26 thickness to the primary coating 24 thickness may be in the range of 0.70 to 0.95, more particularly in the range of 0.75 to 0.90, and most particularly in the range of 0.75 to 0.85. In one or more embodiments, the primary coating 24 may have a thickness in the range of 12-25 microns, or in the range of 12-22 microns, or in the range of 12-19 microns. In one or more embodiments, the secondary coating 26 may have a thickness in the range of 10-20 microns, or in the range of 10-18 microns, or in the range of 10-16 microns. In one or more embodiments, the color layer 28 may have a thickness equal to or less than 10 microns, more particularly equal to or less than 8 microns, and more particularly in the range of 2-8 microns.

In one or more embodiments, the optical fiber 10 has an overall fiber diameter D_{f} equal to or less than 200 microns. More specifically, in one or more embodiments, the overall fiber diameter D_{f} may be in the range of 160-200 microns, or in the range of 160-190 microns, or in the range of 160-180 microns, or in the range of 160-170 microns, or in the range of 170-200 microns, or in the range of 170-190 microns, or in the range of 170-180 microns, or in the range of 180-200 microns, or in the range of 180-190 microns.

In one or more embodiments, the primary coating layer 22 has a Young's modulus (also referred to herein as “elastic modulus”) of less than 1 MPa and a T_{g} (glass transition temperature) of less than −20° C., and the secondary coating layer 24 has a Young's modulus of greater than 1500 MPa and a T_{g} of greater than 65° C.

The primary coating 24 may be made of a known primary coating composition. For example, the primary coating composition may have a formulation listed below in Table 1 which is typical of commercially available primary coating composition.

TABLE 1
Primary Coating Composition

| Component | Amount |
|---|---|
| Oligomeric Material | 50.0 wt % |
| SR504 | 46.5 wt % |
| NVC | 2.0 wt % |
| TPO | 1.5 wt % |
| Irganox 1035 | 1.0 pph |
| 3-Acryloxypropyl | 0.8 pph |
| trimethoxysilane | |
| Pentaerythritol tetrakis(3- | 0.032 pph |
| mercapto propionate) | |

where the oligomeric material may be prepared from H12DMI, HEA, and PPG4000 using a molar ratio n:m:p=3.5:3.0:2.0, H12MDI is 4,4′-methylenebis(cyclohexyl isocyanate) (available from Millipore Sigma), HEA is 2-hydroxyethylacrylate (available from Millipore Sigma), PPG4000 is polypropylene glycol with a number average molecular weight of about 4000 g/mol (available from Covestro), SR504 is ethoxylated(4)nonylphenol acrylate (available from Sartomer), NVC is N-vinylcaprolactam (available from Aldrich), TPO (a photoinitiator) is (2,4,6-trimethylbenzoyl)-diphenyl phosphine oxide (available from BASF), Irganox 1035 (an antioxidant) is benzenepropanoic acid, 3,5-bis(1,1-dimethylethyl)-4-hydroxythiodi-2,1-ethanediyl ester (available from BASF), 3-acryloxypropyl trimethoxysilane is an adhesion promoter (available from Gelest), and pentaerythritol tetrakis(3-mercaptopropionate) (also known as tetrathiol, available from Aldrich) is a chain transfer agent. The concentration unit “pph” refers to an amount relative to a base composition that includes all monomers, oligomers, and photoinitiators. For example, a concentration of 1.0 pph for Irganox 1035 corresponds to 1 g Irganox 1035 per 100 g combined of oligomeric material, SR504, NVC, and TPO.

The secondary coating 26 may be made of a known secondary coating composition. The secondary coating may be prepared from a composition that exhibits high Young's modulus (also referred to as “elastic modulus”). Higher values of Young's modulus may represent improvements that make the secondary coating prepared for the coating composition better suited for small diameter optical fibers. More specifically, the higher values of Young's modulus enable use of thinner secondary coatings on optical fibers without sacrificing performance. Thinner secondary coatings reduce the overall diameter of the optical fiber and provide higher fiber counts in cables of a given cross-sectional area. The Young's modulus of secondary coatings prepared as the secondary coating composition may be equal to or greater than 1500 MPa, more particularly about 1800 MPa or greater, or about 2100 MPa or greater and about 2800 MPa or less or about 2600 MPa or less. The results of tensile property measurements prepared from various curable secondary compositions are listed below in Table 2.

TABLE 2
Tensile Properties of Secondary Coatings

| | Young's |
|---|---|
| | Modulus |
| Composition | (MPa) |
| KB | 1703 |
| A | 2049 |
| SB | 2532 |

A representative curable secondary coating composition is listed below in

TABLE 3
Secondary Coating Composition

| | Composition |
|---|---|
| Component | KB |
| SR601 (wt %) | 30.0 |
| SR602 (wt %) | 37.0 |
| SR349 (wt %) | 30.0 |
| Irgacure 1850 (wt %) | 3.0 |

SR601 is ethoxylated (4) bisphenol A diacrylate (a monomer). SR602 is ethoxylated (10) bisphenol A diacrylate (a monomer). SR349 is ethoxylated (2) bisphenol A diacrylate (a monomer). Irgacure 1850 is bis(2,6-dimethoxybenzoyl)-2,4,4-trimethylpentylphosphine oxide (a photoinitiator).

Secondary coating compositions (A) and (SB) are listed in Table 4.

TABLE 4
Secondary Coating Compositions

| | Composition | |
|---|---|---|
| Component | A | SB |
| PE210 (wt %) | 15.0 | 15.0 |
| M240 (wt %) | 72.0 | 72.0 |
| M2300 (wt %) | 10.0 | — |
| M3130 (wt %) | — | 10.0 |
| TPO (wt %) | 1.5 | 1.5 |
| Irgacure 184 (wt %) | 1.5 | 1.5 |
| Irganox 1035 (pph) | 0.5 | 0.5 |
| DC-190 (pph) | 1.0 | 1.0 |

PE210 is bisphenol-A epoxy diacrylate (available from Miwon Specialty Chemical, Korea), M240 is ethoxylated (4) bisphenol-A diacrylate (available from Miwon Specialty Chemical, Korea), M2300 is ethoxylated (30) bisphenol-A diacrylate (available from Miwon Specialty Chemical, Korea), M3130 is ethoxylated (3) trimethylolpropane triacrylate (available from Miwon Specialty Chemical, Korea), TPO (a photoinitiator) is (2,4,6-trimethylbenzoyl)diphenyl phosphine oxide (available from BASF), Irgacure 184 (a photoinitiator) is 1-hydroxycyclohexyl-phenyl ketone (available from BASF), Irganox 1035 (an antioxidant) is benzenepropanoic acid, 3,5-bis(1,1-dimethylethyl)-4-hydroxythiodi-2,1-ethanediyl ester (available from BASF). DC190 (a slip agent) is silicone-ethylene oxide/propylene oxide copolymer (available from Dow Chemical). The concentration unit “pph” refers to an amount relative to a base composition that includes all monomers and photoinitiators. For example, for secondary coating composition A, a concentration of 1.0 pph for DC-190 corresponds to 1 g DC-190 per 100 g combined of PE210, M240, M2300, TPO, and Irgacure 184.

The Young's modulus of the secondary coatings 26 made from compositions A, KB and SB were measured using the measurement techniques described below.

In particular, the curable secondary coating compositions were cured and configured in the form of cured rod samples for measurement of Young's modulus, tensile strength at yield, yield strength, and elongation at yield. The cured rods were prepared by injecting the curable secondary composition into Teflon® tubing having an inner diameter of about 0.025″. The rod samples were cured using a Fusion D bulb at a dose of about 2.4 J/cm² (measured over a wavelength range of 225-424 nm by a Light Bug model IL390 from International Light). After curing, the Teflon® tubing was stripped away to provide a cured rod sample of the secondary coating composition. The cured rods were allowed to condition for 18-24 hours at 23° C. and 50% relative humidity before testing. Young's modulus was measured using a Sintech MTS Tensile Tester on defect-free rod samples with a gauge length of 51 mm, and a test speed of 250 mm/min.

Tensile properties were measured according to ASTM Standard D882-97. The properties were determined as an average of at least five samples, with defective samples being excluded from the average.

The results show that secondary coatings prepared from compositions KB, A, and SB have Young's moduluses higher than 1500 MPa. Secondary coatings with high Young's modulus as disclosed herein may be better suited for small diameter optical fibers. More specifically, a higher Young's modulus enables use of thinner secondary coatings on optical fibers, thereby enabling smaller fiber diameters without sacrificing performance. Thinner secondary coatings reduce the overall diameter of the optical fiber and provide higher fiber counts in cables of a given cross-sectional area.

Advantageously, an optical fiber 10 constructed as described above has several beneficial thermomechanical and optical properties as discussed below.

In terms of optical properties, coupling losses can be reduced by providing optical fibers with a mode field diameter that is matched to standard single mode fiber. In one or more embodiments, the optical fiber 10 is compliant with ITU-G.652.D and ITU-G.657.A2 specifications. Further, in one or more embodiments, the optical fiber 10 has a mode field diameter (MFD) at 1310 nm of at least 9 microns, or at least 9.1 microns, or at least 9.2 microns.

In one or more embodiments, the optical fiber 10 exhibits a cable cutoff of less than 1260 nm and a zero dispersion wavelength of between 1300 nm and 1324 nm.

In one or more embodiments, the optical fiber 10 experiences a bend loss of less than 0.5 dB/turn at 1550 nm for one bend around a mandrel of diameter of 15 mm. In one or more embodiments, the optical fiber 10 experiences a bend loss of less than 0.1 dB/turn at 1550 nm for one bend around a mandrel of diameter of 20 mm. In one or more embodiments, the optical fiber 10 experiences a bend loss of less than 0.003 dB/turn at 1550 nm for one bend around a mandrel of diameter of 30 mm.

### Examples

Exemplary embodiments of optical fibers 10 (Examples 1-4) that can be incorporated into a high fiber density optical fiber cable are provided in Table 5, below. Examples 1-4 have triangular trenches (as shown in FIG. 3) with trench volumes between 30% Δ-μm² and 60% Δ m² MFD at 1310 nm of 9.1 microns or greater, zero dispersion wavelength between 1300 nm and 1324 nm, cable cutoff of less than 1260 nm, bend loss at 1550 nm for 15 mm mandrel diameter of less than or equal to 0.5 dB/turn, bend loss at 1550 nm for 20 mm mandrel diameter of less than or equal to 0.1 dB/turn and bend loss at 1550 nm for 30 mm mandrel diameter of less than or equal to 0.0034 dB/turn.

TABLE 5
Refractive Index Profile Parameters and Optical Properties of
Optical Fibers having Triangular Trenches

| | Example 1 | Example 2 | Example 3 | Example 4 |
|---|---|---|---|---|
| Maximum Core | 0.336 | 0.37 | 0.332 | 0.385 |
| Index, Almax (%) | | | | |
| Core Radius, | 4.2 | 5.3 | 4.55 | 5.65 |
| R₁ (microns) | | | | |
| Core alpha | 12 | 2.2 | 12 | 2.12 |
| First Cladding | 0 | 0 | 0 | 0 |
| Index, Δ₂ (%) | | | | |
| First Cladding | 7.16 | 7.45 | 9.46 | 8.3 |
| Radius, R₂ | | | | |
| (microns) | | | | |
| Second Cladding | Triangular | Triangular | Triangular | Triangular |
| (Trench) Shape | | | | |
| Second Cladding | −0.5 | −0.55 | −0.33 | −0.28 |
| Min. Index, Δ_{3,min} | | | | |
| (%) | | | | |
| Second Cladding | 15.9 | 14.9 | 18.9 | 16.6 |
| Radius, R₃ | | | | |
| (micron) | | | | |
| Volume of Second | −56.9 | −50.94 | −49.05 | −30 |
| Cladding (Trench) | | | | |
| Region, V₃, | | | | |
| (% Δ-μm²) | | | | |
| Third Cladding | 0 | 0 | 0 | 0 |
| Index, Δ₄ (%) | | | | |
| Third Cladding | 62.5 | 62.5 | 62.5 | 62.5 |
| Radius, R₄ | | | | |
| (microns) | | | | |
| Mode Field | 9.1 | 9.1 | 9.23 | 9.18 |
| Diameter | | | | |
| (micron) at | | | | |
| 1310 nm | | | | |
| Zero Dispersion | 1314 | 1319 | 1317 | 1321 |
| Wavelength (nm) | | | | |
| Dispersion at | −0.36 | −0.837 | −0.644 | −1 |
| 1310 nm | | | | |
| (ps/nm/km) | | | | |
| Dispersion | 0.090 | 0.093 | 0.092 | 0.0909 |
| Slope at 1310 nm | | | | |
| (ps/nm2/km) | | | | |
| Mode Field | 10.21 | 10.22 | 10.34 | 10.41 |
| Diameter | | | | |
| (micron) | | | | |
| at 1550 nm | | | | |
| Dispersion at | 18.32 | 18.27 | 18.2 | 17.61 |
| 1550 nm | | | | |
| (ps/nm/km) | | | | |
| Dispersion | 0.064 | 0.065 | 0.065 | 0.063 |
| Slope at 1550 nm | | | | |
| (ps/nm2/km) | | | | |
| Cable Cutoff (nm) | 1226 | 1204 | 1213 | 1217 |
| Bend Loss | 0.093 | 0.123 | 0.1611 | 0.199 |
| for 15 mm | | | | |
| mandrel diameter | | | | |
| at 1550 nm | | | | |
| (dB/turn) | | | | |
| Bend Loss | 0.023 | 0.113 | 0.0255 | 0.044 |
| for 20 mm | | | | |
| mandrel diameter | | | | |
| at 1550 nm | | | | |
| (dB/turn) | | | | |
| Bend Loss | 0.0025 | 0.0034 | 0.0032 | 0.0024 |
| for 30 mm | | | | |
| mandrel diameter | | | | |
| at 1550 nm | | | | |
| (dB/turn) | | | | |

Table 6 provides examples of optical fibers 10 having rectangular trenches (as shown in FIG. 2) with trench volumes between 30% Δ-μm² and 60% Δ-μm², MFD at 1310 nm of 9.1 microns or greater, zero dispersion wavelength between 1300 nm and 1324 nm, cable cutoff of less than 1260 nm, bend loss at 1550 nm for 15 mm mandrel diameter of less than or equal to 0.5 dB/turn, bend loss at 1550 nm for 20 mm mandrel diameter of less than or equal to 0.1 dB/turn and bend loss at 1550 nm for 30 mm mandrel diameter of less than or equal to 0.0034 dB/turn.

TABLE 6
Refractive Index Profile Parameters and Optical Properties of
Optical Fibers having Rectangular Trenches

| | Example 5 | Example 6 | Example 7 | Example 8 |
|---|---|---|---|---|
| Maximum Core | 0.337 | 0.337 | 0.332 | 0.337 |
| Index, Δ₁ₘₐₓ (%) | | | | |
| Core Radius, | 4.55 | 4.6 | 4.55 | 4.5 |
| R₁ (microns) | | | | |
| Core alpha | 12 | 12 | 12 | 12 |
| First Cladding | 0 | 0 | 0 | 0 |
| Index, Δ₂ (%) | | | | |
| First Cladding | 10.6 | 10.42 | 10.9 | 10.2 |
| Radius, R₂ | | | | |
| (microns) | | | | |
| Second Cladding | Rectangular | Rectangular | Rectangular | Rectangular |
| (Trench) Shape | | | | |
| Second Cladding | −0.4 | −0.2 | −0.2 | −0.4 |
| Min. Index, | | | | |
| Δ₃,ₘᵢₙ (%) | | | | |
| Second Cladding | 15.75 | 17 | 18.9 | 13.4 |
| Radius, R₃ | | | | |
| (micron) | | | | |
| Volume of Second | −54.28 | −36.72 | −48.44 | 32 |
| Cladding (Trench) | | | | |
| Region, V₃, | | | | |
| (% Δ-μm²) | | | | |
| Third Cladding | 0 | 0 | 0 | 0 |
| Index, Δ₄ (%) | | | | |
| Third Cladding | 62.5 | 62.5 | 62.5 | 62.5 |
| Radius, R₄ | | | | |
| (microns) | | | | |
| Mode Field | 9.172 | 9.19 | 9.23 | 9.17 |
| Diameter | | | | |
| (micron) at 1310 | | | | |
| nm | | | | |
| Zero Dispersion | 1311 | 1315 | 1313 | 1309 |
| Wavelength (nm) | | | | |
| Dispersion at | −0.092 | −0.46 | −0.28 | 0.09 |
| 1310 nm | | | | |
| (ps/nm/km) | | | | |
| Dispersion | 0.092 | 0.092 | 0.092 | 0.091 |
| Slope at 1310 nm | | | | |
| (ps/nm2/km) | | | | |
| Mode Field | 10.4 | 10.4 | 10.42 | 10.3 |
| Diameter | | | | |
| (micron) at 1550 | | | | |
| nm | | | | |
| Dispersion at | 18.2 | 18.2 | 18.2 | 18.2 |
| 1550 nm | | | | |
| (ps/nm/km) | | | | |
| Dispersion | 0.065 | 0.065 | 0.065 | 0.066 |
| Slope at 1550 nm | | | | |
| (ps/nm2/km) | | | | |
| Cable Cutoff (nm) | 1253 | 1205 | 1215 | 1220 |
| Bend Loss | 0.093 | 0.2947 | 0.1408 | 0.41 |
| for 15 mm | | | | |
| mandrel diameter | | | | |
| at 1550 nm | | | | |
| (dB/turn) | | | | |
| Bend Loss | 0.04 | 0.0295 | 0.022 | 0.149 |
| for 20 mm | | | | |
| mandrel diameter | | | | |
| at 1550 nm | | | | |
| (dB/turn) | | | | |
| Bend Loss | 0.0011 | 0.003 | 0.0027 | 0.0034 |
| for 30 mm | | | | |
| mandrel diameter | | | | |
| at 1550 nm | | | | |
| (dB/turn) | | | | |

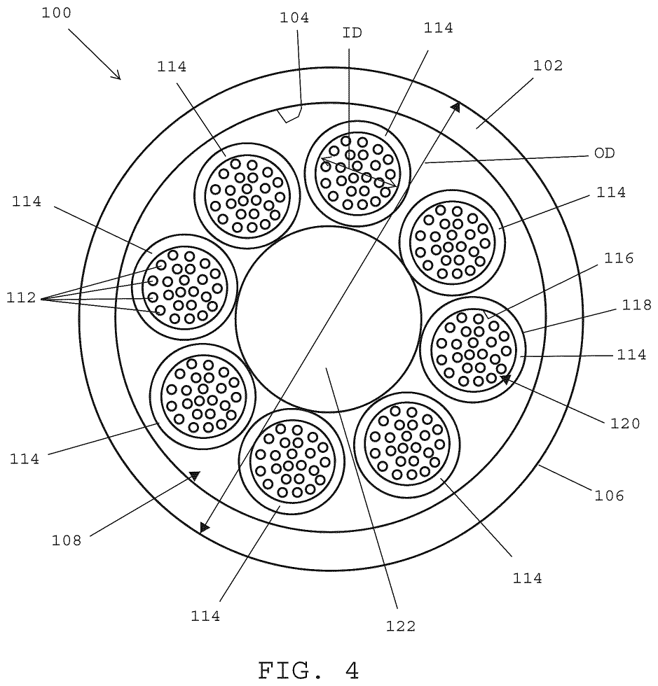

Having described an optical fiber design, the following discussion pertains to an optical fiber cable having a high density of fibers using the described optical fibers, while still maintaining crush resistance and avoiding bend loss, including at low temperatures. FIG. 4 depicts an embodiment of an optical fiber cable 100 according to the present disclosure. The optical fiber cable 100 includes a cable jacket 102 having an inner surface 104 and an outer surface 106. The inner surface 104 defines a central cable bore 108. In one or more embodiments, the outer surface 106 defines an outermost surface of the optical fiber cable 100. Further, in embodiments, the outer surface 106 defines an outer diameter OD of the optical fiber cable 100. In embodiments, the outer diameter OD of the optical fiber cable 100 is from about 4 mm to about 15 mm, in particular about 5 mm to about 10 mm, and particularly about 6 mm to about 9 mm.

Disposed within the central cable bore 108 are a plurality of optical fibers 112 as described above and as shown in FIGS. 1-3. In the embodiment depicted, the optical fibers 112 are arranged in a loose tube configuration within a plurality of buffer tubes 114. Each buffer tube 114 has an interior surface 116 and an exterior surface 118. The optical fibers 112 are provided within a central buffer tube bore 120 defined by the interior surface 116 of the buffer tube 114. In one or more embodiments, each buffer tube 114 includes from twelve to thirty-six optical fibers 112, in particular twenty-four optical fibers 112. Further, in one or more embodiments, the optical fiber cable 100 includes more than six buffer tubes 114, such as from six to sixteen buffer tubes 114, in particular eight to twelve buffer tubes 114. In one or more embodiments, an optical fiber cable 100 so constructed may include, for example, from 192 to 288 optical fibers 112. Based on the number of optical fibers 112 within the optical fiber cable 100 and the cross-sectional area of the optical fiber cable 100 (as defined by the outer diameter OD), a fiber density can be calculated. In embodiments, the fiber density of the optical fiber cable is at least 3.25 fibers/mm², at least 3.5 fibers/mm², at least 3.75 fibers/mm², at least 4 fibers/mm², at least 4.25 fibers/mm², at least 4.5 fibers/mm², at least 4.75 fibers/mm², or at least 5 fibers/mm². In embodiments, the fiber density is up to 6 fibers/mm².

In the embodiment depicted in FIG. 4, the buffer tubes 114 are disposed around a central strength member 122. In one or more embodiments, the strength member 122 comprises glass-reinforced plastic rods, fiber-reinforced plastic rods, or metal strands, among others. Further, in embodiments, the strength member 122 comprises a diameter of 0.5 mm to 1.5 mm, in particular 0.75 mm to 1.25 mm, more particularly about 1.2 mm.

Optical fiber cables 100 having optical fibers 112 arranged within buffer tubes 114 in a loose tube configuration are designed with a particular amount of free space. Free space within the buffer tube 114 is defined as

$$Free Space = 1 - \frac{{A}_{F}}{{A}_{Tube , ID}}$$

where Δ_{F} is the sum of the cross-sectional areas of all the optical fibers 112 in a single buffer tube 114, and Δ_{Tube,ID} is the cross-sectional area of the buffer tube 114 as measured from the interior surface 116 of the buffer tube 114. Free space within a buffer tube 114 provides room for the optical fibers 112 to move during bending without causing unacceptable attenuation.

Further, optical fiber cables 100 are designed with an amount of excess fiber length (EFL) in the optical fiber cable 100. In part, the excess fiber length (EFL) creates a tensile window for the cable such that, when a load is applied to the cable, EFL allows for the strength member 122 in the optical fiber cable 100 to take some of the load before the optical fibers 112 begin to strain. In relatively small, high density cables, EFL is generally minimized, approaching zero in certain designs. In such designs, free space in the tube is reduced to reduce the cable diameter, and thus, there is little room for the excess fiber to accumulate.

During low temperature conditions, polymeric materials, which comprise the buffer tube and jacket, tend to shrink. When the cable (and buffer tube) shrinks, EFL is generated within the cable. For cables with EFL at room temperature, the EFL in the cable gets even higher. For cables with near zero EFL at room temperature, some EFL is generated at low temperatures. The excess fiber length relative to the tube length accumulates in the buffer tube's free space. If the free space is insufficient to accommodate the additional fiber length, then fiber buckling can create macrobending, and pressure of the optical fibers against the interior surface of the buffer tube and against adjacent optical fibers can create microbending.

Optical fiber characteristics impact the amount of resulting attenuation. Lowering the optical fiber diameter generates more free space in a given optical fiber cable construction, and therefore allows for less attenuation at a given cold temperature. Improving bend performance allows the fiber to experience more buckling within a contracting buffer tube before attenuation results. Improved microbend performance allows the fiber to experience pressure against the inner tube wall and adjacent fibers with a lower degree of attenuation.

However, free space in a buffer tube is inversely related to fiber density of a cable. For a given construction, as free space in a buffer tube is minimized, the buffer tube diameter is also minimized (assuming that the buffer tube thickness remains constant). This, in turn, minimizes the optical fiber cable diameter, which minimizes the cross-sectional area of the optical fiber cable and increases the fiber density.

A conventional optical fiber cable design (design 1 in Table 7, below) that included 96 optical fibers had a fiber density of 3.08 fibers/mm². The free space in the buffer tube for this design is 38%. The buffer tube ID is 1.1 mm, the optical fiber diameter is 0.250 mm. Further, in the conventional design, each buffer tube contained twelve optical fibers, and the optical fiber cable included eight buffer tubes. Using small diameter optical fibers 112 as described above, various optical fiber cable constructions are proposed in Table 7. In particular, designs 2 and 3 include 192 optical fibers 112 in buffer tubes 114 having an outer diameter of 1.43 mm and an inner diameter ID of 1.22-1.275 mm. Designs 2 and 3 included 24 fibers 112 in each buffer tube 114. Design 2 utilized 200 micron optical fibers 112 having a fiber diameter of 0.208 mm including the color layer. The optical fibers of design 2 are low bend loss optical fibers but only have an A1 rating according to ITU-T G.657. Further, the optical fibers of design 2 have a mode field diameter of less than 9 μm at 1310 nm. The free space in design 2 ranged from 30-36% depending on the buffer tube ID. Design 3 utilized 190 micron optical fibers 112 having a fiber diameter of 0.198 mm with the color layer. The optical fibers of design 3 were according to the present disclosure, in particular A2 rating according to ITU-T G.657 and a mode field diameter of at least 9 μm at 1310 nm. The free space in design 3 ranged from 37-42% depending on the buffer tube ID.

TABLE 7
Optical Fiber Cable Designs and Associated Free Space

| Cable | Fibers/ | Fiber OD | Buffer Tube ID | Free space |
|---|---|---|---|---|
| Design | Tube | (mm) | (mm) | (%) |
| 1 | 12 | 0.250 | 1.1 | 38% |
| 2 | 24 | 0.208 | 1.22-1.275 | 30-36% |
| 3 | 24 | 0.198 | 1.22-1.275 | 37-42% |

The absolute minimum free space in a buffer tube with twelve optical fibers in a round buffer tube is about 26%. The buffer tube ID will reduce to about 0.84 mm with 0.208 mm optical fibers having a color layer. At an ID of 1.1 mm, all twelve of the 0.208 mm optical fibers have enough room to wrap around the interior surface of the buffer tube and equally have the opportunity to accommodate EFL as the cable contracts from thermal effects. With a smaller buffer tube, some optical fibers will be confined to an inner layer because of positional constraint of the fibers. This gives rise to a reduced effective buffer tube ID for a few optical fibers, and these optical fibers can experience a greater thermal response than the fibers able to reach the interior surface of the buffer tube. In this situation, it is advantageous to employ bend resistant fibers of the type described above to increase the tolerance to increased EFL in a reduced free space environment.

For buffer tubes 114 having twenty-four optical fibers 112, a 1.275 mm ID tube accommodates twenty-four optical fibers 112 having a fiber diameter of 0.208 mm with a resulting free space of about 36%. Pushing these optical fibers 112 to the interior surface of the buffer tube results in more fibers having a relatively reduced EFL capacity by the positional constraint imposed.

Based on the foregoing discussion, it can be seen that the cable construction using small diameter, bend resistant optical fibers provides enhanced customizability of cables for various contexts. For example, providing lower free space in a buffer tube enables the same cold temperature performance to be achieved in a buffer tube of the same diameter but having a greater buffer tube thickness. Further, the thicker buffer tube will have improved crush and kink resistance. Still further, the lower free space in the buffer tube allows for the same cold temperature performance to be achieved in a cable of smaller diameter by increasing fiber density.

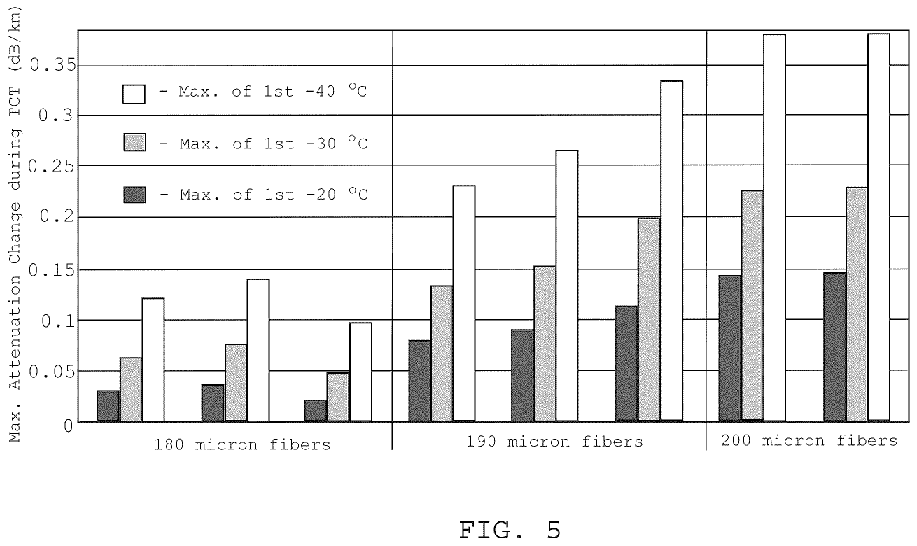

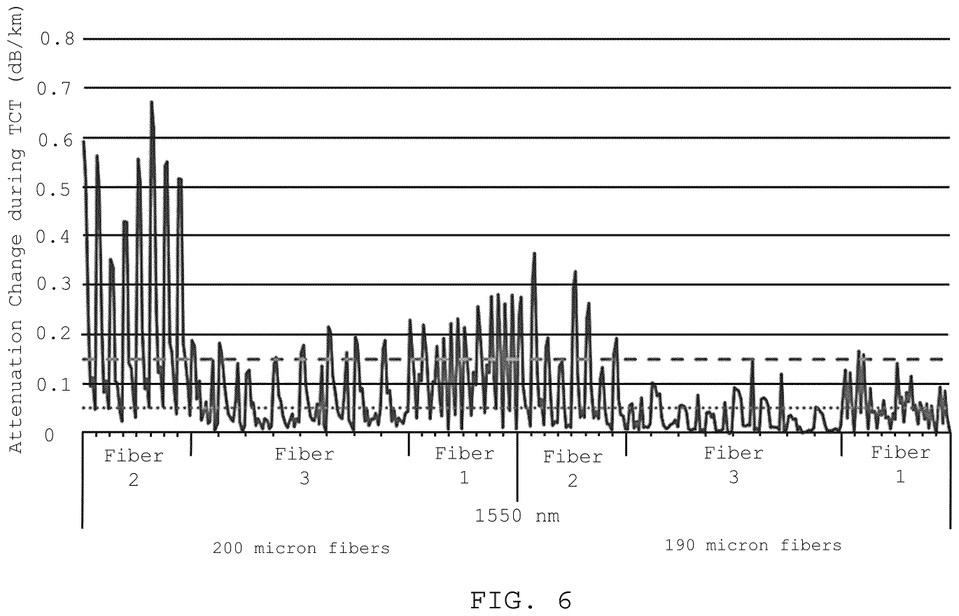

FIGS. 5 and 6 demonstrate the maximum attenuation resulting from thermal cycle testing of optical fiber cables 100 as described hereinabove. In particular, both FIGS. 5 and 6 present a form of thermal cycling test performance. Referring first to FIG. 5, the maximum attenuation change during thermal cycling for optical fibers of three different sizes is shown. In particular, the thermal cycling data shown in FIG. 5 considered a test cable having eight buffer tubes. The test cable was placed in the test chamber, initially at room temperature (about 20° C. to 25° C.), and the temperature was lowered to −40° C., raised to 75° C., lowered to −40° C., raised to 75° C., and brought back to room temperature. The attenuation of the fibers in the test cable was measured at various temperatures. The maximum attenuation at the first −20° C., the first −30° C., and the first −40° C. (i.e., the attenuation as measured during the first cycle down to −40° C.) are shown in FIG. 5.

Of the eight buffer tubes in the test cable, three buffer tubes included optical fibers having diameters of 180 microns. Another three buffer tubes included optical fibers having diameters of 190 microns, and two buffer tubes included optical fibers having diameters of 200 microns. Each buffer tube ID was 1.2 mm, and the free space was 41%, 35%, and 28% for the 180, 190, and 200 micron fibers, respectively. From the chart in FIG. 5, it can be seen that the cable having 180 micron optical fibers exhibited a maximum attenuation of less than 0.05 dB/km at −20° C., less than 0.10 dB/km at −30° C., and less than 0.15 dB/km at −40° C. The cable having 190 micron fibers exhibited a maximum attenuation of less than 0.15 dB/km at −20° C., less than 0.20 dB/km at −30° C., and less than 0.35 dB/km at −40° C. The cable having 200 micron fibers exhibited a maximum of attenuation of less than 0.2 dB/km at −20° C., less than 0.3 dB/km at −30° C., and less than 0.5 dB/km at −40° C. Thus, FIG. 5 demonstrates that, as fiber diameter decreases, the thermal cycling improves.

FIG. 6 demonstrates depicts attenuation for two test cables in which all of the optical fibers in each test cable had the same diameter but were of three different fiber types. In particular, in one test cable, all of the optical fibers had a diameter of 190 microns, and in the other test cable, all of the fibers had a diameter of 200 microns. Regarding fiber types, a first fiber type (“Fiber 1”) is according to the present disclosure, i.e., A2 rating according to ITU-T G.657 and a mode filed diameter of at least 9 microns at 1310 nm. The second fiber type (“Fiber 2”) has an A1 rating according to ITU-T G.657 and a mode field diameter of about 9.2 microns at 1310 nm. The third fiber type (“Fiber 3”) has an A2 rating according to ITU-T G.657 and a mode field diameter of about 8.6 microns at 1310 nm. The three types of optical fibers were included in equal amounts in each of the eight buffer tubes in the test cables. The test cables were thermally cycled as described above, and FIG. 6 depicts the maximum attenuation of each fiber type in each of the buffer tubes of the test cables for the second −40° C. (i.e., after the first −40° C. and after cycling to 75° C. one time).

As can be seen in FIG. 6, Fiber 2, which had the A1 rating, has the greatest attenuation of the three tested fiber types at both fiber diameters. Fibers 1 and 3 performed similarly as would be expected from both having an A2 rating. However, Fiber 1 has the advantage of a mode field diameter of greater than 9 microns at 1310 nm, which is matched to standard single mode fibers so as to reduce coupling losses. Further, Fiber 1 has the advantage of being relatively less expensive than Fiber 3.

As mentioned above, the small diameter optical fibers can be leveraged to enhance free space. However, the small diameter optical fibers can also facilitate improvement to kink and crush performance by allowing for thicker buffer tube jackets.

To predict the crush/kink performance, the following deflection model can be used:

$$\frac{D}{2} = \frac{π {FR}^{3}}{4 EI}$$

where D is the deflection of a buffer tube, F is the compressive load, R is average radius of the tube, E is flexural modulus, and I is the moment of inertia. For a cylinder, the moment of inertia can be calculated as

$$I = \frac{L {t}^{3}}{12}$$

where L is the length of crush plates acting on the cylinder, and t is cylinder (or buffer tube) thickness. By combining these equations, the deflection of a buffer tube under compressive load is proportional to R³/t³. This means that crush performance of a buffer tube can be improved by increasing the thickness of the buffer tube. In this regard, the higher t³/R³, the greater the buffer tube robustness. The amount of tube crush, or tube deflection reduces with the thickness cubed. Increasing tube thickness results in a smaller tube inner diameter, and therefore less free space in a buffer tube. With improved attenuation fiber, temperature performance of the buffer tube can be maintained despite the decrease in free space. Also, with lower fiber diameter, the temperature performance of the tube can be maintained because the decrease in free space can be mitigated. By combining improved attenuation and low diameter fiber, tube robustness, fiber density, and temperature performance can be achieved for a variety of applications.

Various modifications and alterations may be made to the examples within the scope of the claims, and aspects of the different examples may be combined in different ways to achieve further examples. Accordingly, the true scope of the claims is to be understood from the entirety of the present disclosure in view of, but not limited to, the embodiments described herein.

It will be apparent to those skilled in the art that various modifications and variations can be made without departing from the spirit or scope of the claims.

What is claimed is:

1. An optical fiber cable, comprising:
a cable jacket comprising an inner surface and an outer surface, the inner surface defining a central cable bore and the outer surface defining an outermost surface of the optical fiber cable and a cable cross-sectional area (A_{C});
at least one buffer tube disposed within the central cable bore, each buffer tube of the at least one buffer tube comprising an interior surface defining a buffer tube cross-sectional area (A_{Tube, ID});
a plurality of optical fibers (N) disposed within the at least one buffer tube;
wherein each optical fiber of the plurality of optical fibers comprises a fiber diameter of 160 microns to 200 microns;
wherein the plurality of optical fibers comprise a total fiber area (A_{F});
wherein the buffer tube comprises a free space (1−A_{F}/A_{Tube, ID}) of at least 37%; and
wherein the optical fiber cable comprises a fiber density (N/A_{C}) of at least 3.25 fibers/mm².

2. The optical fiber cable of claim 1, wherein the at least one buffer tube comprises six or more buffer tubes.

3. The optical fiber cable of claim 2, wherein the plurality of optical fibers comprises from twelve to thirty-six optical fibers.

4. The optical fiber cable of claim 3, wherein the fiber density is from 3.5 fibers/mm² to 6 fibers/mm².

5. The optical fiber cable of claim 4, wherein the buffer tubes are disposed around a central strength member.

6. The optical fiber cable of claim 1, wherein each optical fiber of the plurality of optical fibers comprises a germania-doped silica core and a fluorine-doped silica trench.

7. The optical fiber cable of claim 6, wherein the fluorine-doped silica trench is rectangular.

8. The optical fiber cable of claim 6, wherein the fluorine-doped silica trench is triangular.

9. The optical fiber cable of claim 6, wherein the fluorine-doped silica trench comprises a trench volume of from 25% Δ microns² to 70% Δ microns².

10. The optical fiber cable of claim 1, wherein the free space is up to 42%.

11. The optical fiber cable of claim 1, comprising a bend loss of less than 0.5 dB/turn at 1550 nm for one bend around a mandrel of diameter of 15 mm, a bend loss of less than 0.1 dB/turn at 1550 nm for one bend around a mandrel of diameter of 20 mm, and a bend loss of less than 0.003 dB/turn at 1550 nm for one bend around a mandrel of diameter of 30 mm.

12. An optical fiber cable, comprising:
a cable jacket comprising an inner surface and an outer surface, the inner surface defining a central cable bore and the outer surface defining an outermost surface of the optical fiber cable and a cable cross-sectional area (A_{C});
a plurality of buffer tubes disposed within the central cable bore;
a number of optical fibers (N) disposed within the plurality of buffer tubes such that each buffer tube of the plurality of buffer tubes includes at least twelve optical fibers;
wherein each optical fiber of the number of optical fibers comprises:
a germania-doped silica core;
a cladding region comprising a fluorine-doped silica trench;
a primary coating having a first elastic modulus of less than 1 MPa and a first glass transition temperature of less than −20° C.; and
a secondary coating having a second elastic modulus of greater than 1500 MPa and a second glass transition temperature of greater than 65° C.; and
wherein the number of optical fibers is at least 192 and the optical fiber cable comprises a fiber density (N/A_{C}) of at least 3.25 fibers/mm².

13. The optical fiber cable of claim 12, wherein each buffer tube of the plurality of buffer tubes comprises an interior surface defining a buffer tube cross-sectional area (A_{Tube, ID}), wherein the number of optical fibers comprise a total fiber area (A_{F}), and wherein the buffer tube comprises a free space (1−A_{F}/A_{Tube, ID}) of at least 37%.

14. The optical fiber cable of claim 13, wherein the free space is up to 42%.

15. The optical fiber cable of claim 13, wherein each optical fiber of the number of optical fibers comprises a fiber diameter of 160 microns to 200 microns;

16. The optical fiber cable of claim 12, wherein the fluorine-doped silica trench is rectangular.

17. The optical fiber cable of claim 12, wherein the fluorine-doped silica trench is triangular.

18. The optical fiber cable of claim 12, wherein the fluorine-doped silica trench comprises a trench volume of from 25% Δ microns² to 70% Δ microns².

19. The optical fiber cable of claim 12, wherein the fiber density is from 3.5 fibers/mm² to 6 fibers/mm².

20. The optical fiber cable of claim 12, comprising a bend loss of less than 0.5 dB/turn at 1550 nm for one bend around a mandrel of diameter of 15 mm, a bend loss of less than 0.1 dB/turn at 1550 nm for one bend around a mandrel of diameter of 20 mm, and a bend loss of less than 0.003 dB/turn at 1550 nm for one bend around a mandrel of diameter of 30 mm.
